(19) United States
(12) Patent Application Publication
(10) Pub. No.: US 2010/0194725 A1
(43) Pub. Date: Aug. 5, 2010

(54) Display Apparatus

(75) Inventors: Tomonori YOSHIDA, Osaka (JP); Takahiro KONDO, Osaka (JP); Hidenori SATO, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/699,381

(22) Filed: Feb. 3, 2010

(30) Foreign Application Priority Data
Feb. 3, 2009 (JP) 2009-022924

(51) Int. Cl. G09G 5/00

(52) U.S. Cl. 345/207

(57) ABSTRACT

A display apparatus includes an illumination acquisition part acquiring the illumination of outdoor daylight, a time acquisition part acquiring date and/or time, a control part controlling display luminosity according to the output of the illumination acquisition part, wherein the control part is characterized by determining the control range of a display luminosity based on the date and/or time the time acquisition part acquired.

This application claims priority under 35 U.S.C. §119 from Japanese patent application number 2009-022924, filed Feb. 3, 2009, which application is hereby incorporated by reference herein.

### BACKGROUND OF THE INVENTION

1. Field of the Invention

The present invention relates to generally to display apparatus and in particular to such display apparatus in outdoor installations, which present considerations of exposure to environmental conditions such as extreme temperatures, moisture, and contamination due to dust or debris.

2. Description of Related Art

In recent years, display apparatus which can be installed outdoors have been proposed. In particular, liquid crystal displays having a flat screen and high resolution have been proposed as candidates for outdoor installations. However, to install these displays outdoors, it is necessary to consider the environmental factors.

For example, in order to maintain sufficiently visibility in strong sunlight, it is necessary to make the display portion of the liquid crystal display brighter. However, if high luminosity of a backlight is maintained, the power consumption becomes large. Moreover the luminosity may be too high, or may change too rapidly such that it would have a discomforting effect on viewers.

Therefore, the level of the backlight may be changed according to the quantity of sunlight received by a sensor placed at the surface side of the panel. For example, the level of the backlight may be increased when the received sunlight is large, and the level may be reduced when the received sunlight is small.

However, according to the above method, it may give viewers a sense of discomfort when the level of the backlight changes rapidly due to a rapid change of received sunlight. For example, if large size vehicles such as trucks or buses stop in front of the display frequently, the display gets shadowed frequently as well. And thus the level of the backlight changes frequently, and may give viewers a sense of discomfort.

In order to alleviate such discomforts, it might be effective to make the tracking of the backlight slower against the received sunlight. However, slowing the tracking may make it take too long to increase the luminosity before the display becomes viewable.

### SUMMARY OF THE INVENTION

A display apparatus of present invention has an illumination acquisition part acquiring the illumination of daylight that is representative of an amount of the daylight on the display panel, a time acquisition part acquiring date and/or time, a control part controlling display luminosity according to the output of the illumination acquisition part, wherein the control part is characterized by determining the control range of a display luminosity based on the date and/or time the time acquisition part acquired.

### BRIEF DESCRIPTION OF THE DRAWINGS

FIG. 1 is a block diagram of a liquid crystal display apparatus in accordance with the present invention.

FIG. 2 is a flow chart showing the luminosity control of backlight of the liquid crystal display apparatus in accordance with the present invention.

FIG. 3 is a graph showing an example of solar radiation data of January in London. The luminosity control of backlight of the liquid crystal display apparatus. The horizontal axis represents time and the vertical axis represents the amount of solar radiation per time, such as per hour.

### DETAILED DESCRIPTION OF THE INVENTION

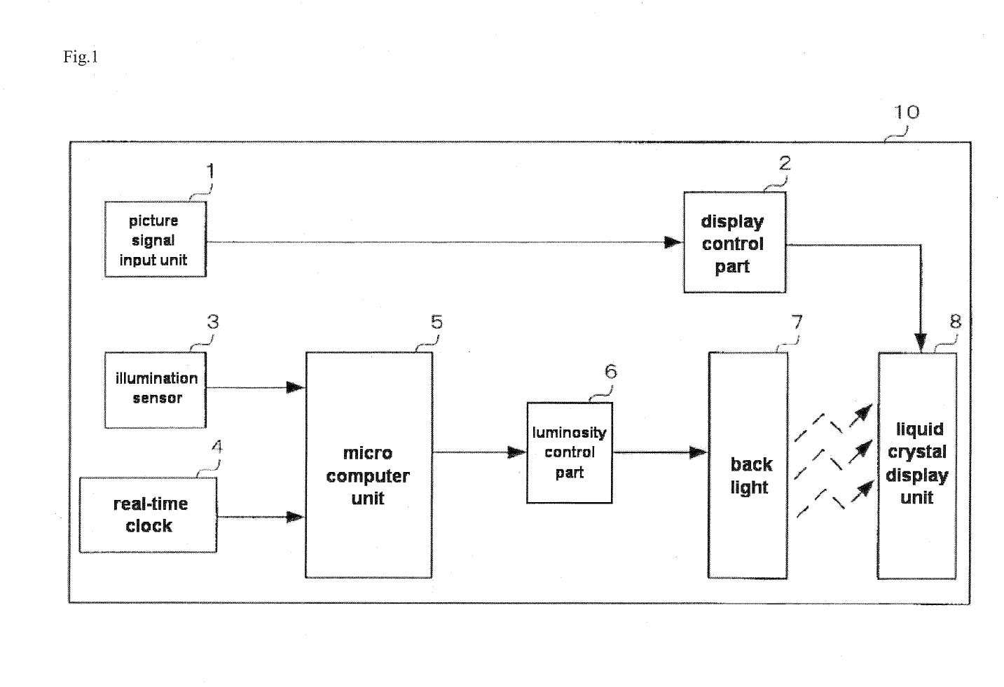

The present invention as embodied in a crystal display apparatus will be specifically described below with the reference to the drawings. FIG. 1 shows a block diagram of the crystal display apparatus.

As shown in FIG. 1, the liquid crystal display 10 has a picture signal input unit 1, a display controller 2, an illumination sensor 3, a real-time clock 4, a microcomputer unit 5, a luminosity controller 6, a backlight 7, and a liquid crystal display unit 8.

The picture signal input unit 1 is connected to a LAN (Local Area Network) for example, and a picture signal is inputted via the LAN, and the unit 1 outputs the picture signal in DVI (Digital Visual Interface) format. The display controller 2 converts a picture signal input from the unit 1 into a suitable format for the liquid crystal display unit 8, and outputs the converted signal to the unit 8, and an image is displayed in the unit 8.

The backlight 7 irradiates light from the back side of the liquid crystal display unit 8 so that a viewer may see the image formed by the liquid crystal display unit, and is implemented by a CCFL (Cold Cathode Fluorescent Lamp) for example. The microcomputer unit 5 outputs a backlight control signal indicating the luminosity of the backlight 7 to the luminosity controller 6. The controller 6 outputs a PWM (Pulse Width Modulation) driving signal based on the control signal from the unit 5 to the backlight 7. The backlight 7 emits light at a level according to the PWM driving signal from the controller 6.

The illumination sensor 3 is connected to the microcomputer unit 5, and when the sensor 3 detects sunlight, it outputs an illumination detection signal to the unit 5. Then the microcomputer unit 5 acquires illumination information by A/D conversion of the detection signal from the sensor 3. The sensor 3 is arranged in the display surface side of the display unit 8, for example.

The real-time clock 4 is connected to the microcomputer unit 5 as well, and the unit 5 acquires time information (i.e. date, month, and time) from the clock 4.

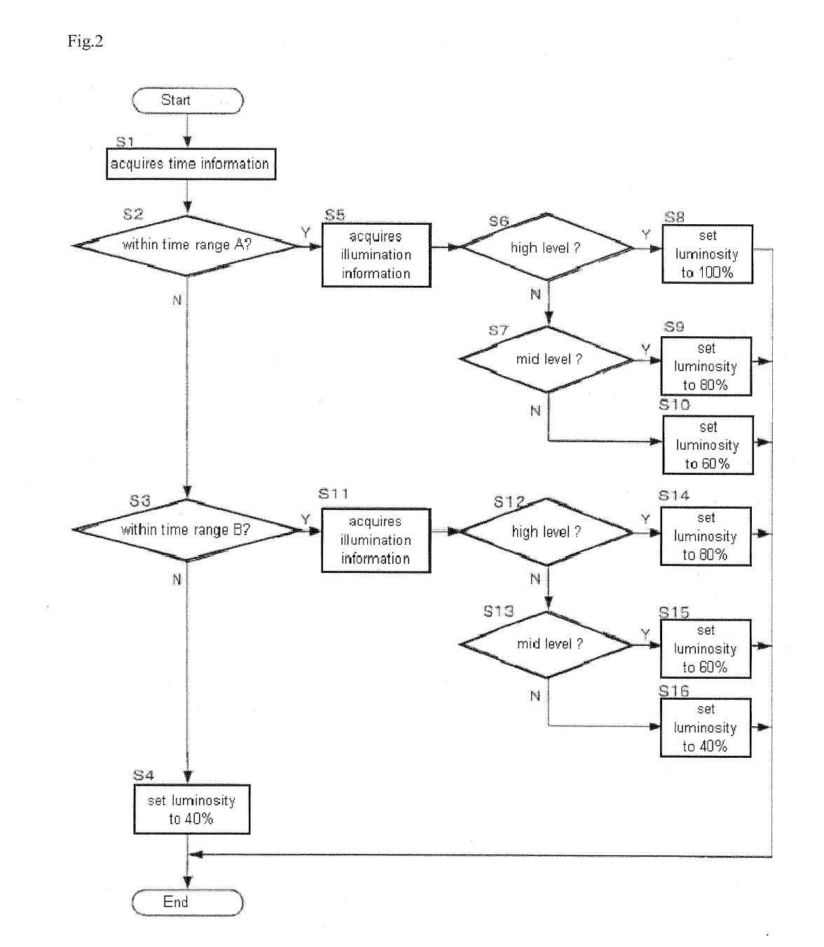

Hereafter, a luminosity control of the backlight 7 in the liquid crystal display 10 is explained with reference to the flow chart shown in FIG. 2.

A process shown by the flow chart of FIG. 2 is performed periodically. First, the microcomputer unit 5 acquires time information from the real-time clock 4 (step S1). The microcomputer unit 5 then determines whether the acquired time is within the time range A as shown in Table 1 (step S2).

TABLE 1

| | | | Time |
|---|---|---|---|
| | Time Range A | Time Range B | Range C |
| January | 9 am to 4 pm | 8 am to 9 am or 4 pm to 5 pm | Otherwise |
| February | 8 am to 5 pm | 7 am to 8 am or 5 pm to 6 pm | Otherwise |
| March | 7 am to 6 pm | 6 am to 7 am or 6 pm to 7 pm | Otherwise |
| April | 7 am to 7 pm | 6 am to 7 am or 7 pm to 8 pm | Otherwise |
| May | 6 am to 8 pm | 5 am to 6 am or 8 pm to 9 pm | Otherwise |
| June | 6 am to 8 pm | 5 am to 6 am or 8 pm to 9 pm | Otherwise |
| July | 6 am to 8 pm | 5 am to 6 am or 8 pm to 9 pm | Otherwise |
| August | 6 am to 8 pm | 5 am to 6 am or 8 pm to 9 pm | Otherwise |
| September | 7 am to 7 pm | 6 am to 7 am or 7 pm to 8 pm | Otherwise |
| October | 8 am to 5 pm | 7 am to 8 am or 5 pm to 6 pm | Otherwise |
| November | 8 am to 4 pm | 7 am to 8 am or 4 pm to 5 pm | Otherwise |
| December | 9 am to 3 pm | 8 am to 9 am or 3 pm to 4 pm | Otherwise |

Table 1 shows a time range configured for each month which is determined based on the meteorological data of the geographic location of the installation. Time range A is a daytime period, for example, and the luminosity of the backlight 7 is controlled between 100% and 60%. In other words, the output of the backlight is controlled between 100% and 60% of the rated output or the maximum output during this time period. Time range B is sunrise time or sunset time, for example, and the luminosity of the backlight 7 is controlled between 80% and 40%. In other words, the output of the backlight is controlled between 80% and 60% of the rated output or the maximum output during this time period. Time range C is nighttime, for example, and the luminosity of the backlight 7 is controlled at 25%. In other words, the output of the backlight is fixed at 25% of the rated output or the maximum output during this time period. In this case, the table is based on the meteorological data of London.

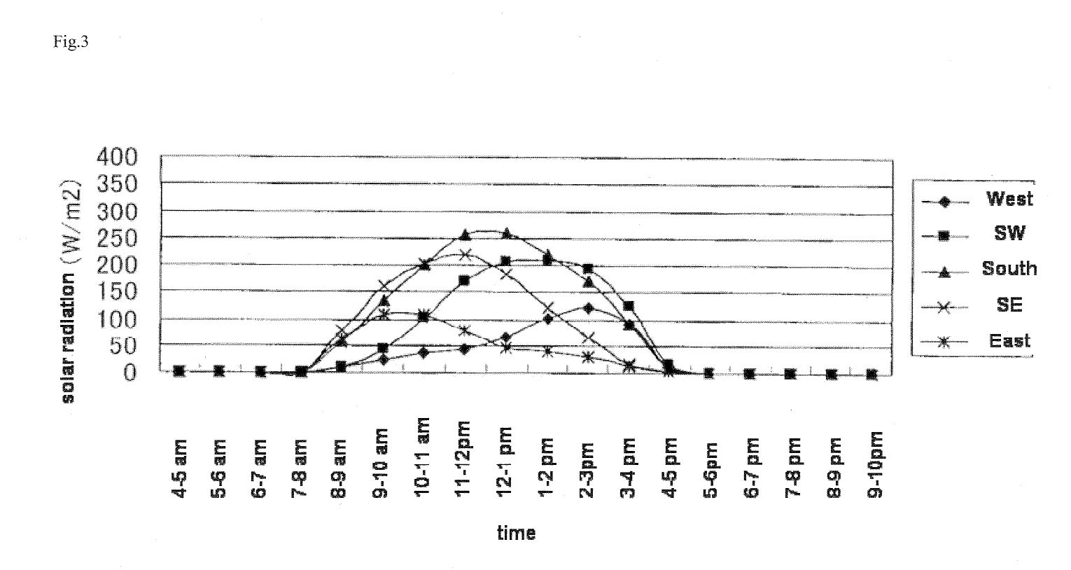

FIG. 3 is a graph showing the example of the solar radiation data in January in London. The horizontal axis represents time and the vertical axis represents the amount of solar radiation per unit time such as per hour. Here, the data is the average radiation between the years 1996 and 2000. According to FIG. 3, from 9 am to 4 pm, since the radiation may exceed 100 [W/m²] depending on the direction, the luminosity control range of the backlight in January is set between 100% and 60% during time range A (from 9 am to 4 pm). An hour period before and after the time range A, i.e. 8 am to 9 am and 4 pm to 5 pm are sunrise time and sunset time respectively, and since the circumference is presumably bright, the luminosity of the backlight is set between 80% and 40% during this time. During the time except above time range A and B (i.e. time range c), since it is presumably a nighttime, the luminosity of the backlight is fixed to 25%.

When it is determined that the acquired time is within the time range A (i.e. “yes” in step S2), the microcomputer unit 5 determines the luminosity control range of the backlight 7 between 100% and 60%, then proceeds to Step S5.

In step S5, the microcomputer unit 5 acquires illumination information based on the illumination detection signal from the illumination sensor 3. The microcomputer unit 5 then determines whether the acquired illumination belongs to the high level range among the level ranges of high, middle, and low. When it is determined that it belongs to the high range (i.e. “yes” in step S6), then in step S8, the microcomputer unit 5 outputs the backlight control signal to the luminosity controller 6 so that the luminosity of the backlight gradually changes from the current luminosity to 100% luminosity, which is the maximum of the luminosity range during the time range A period. By a PWM drive signal from the luminosity controller 6, the luminosity of the backlight 7 changes from the current luminosity to 100%. If current luminosity is already 100%, the microcomputer unit 5 does not output the backlight control signal, thus 100% luminosity is maintained.

When it is determined that the acquired illumination does not belong to the high level range (i.e. “no” in step S6), then in step S7, the microcomputer unit 5 determines whether the acquired illumination belongs to the middle level range. When it is determined that it belongs to the middle level range (i.e. “yes” in step S7), then in step S9, the microcomputer unit 5 outputs the backlight control signal to the luminosity controller 6 so that the luminosity gradually changes from the current luminosity to 80% luminosity, which is the average of the luminosity range in the time range B period. If current luminosity is already 80%, the microcomputer unit 5 does not output the backlight control signal, thus the 80% luminosity is maintained.

When it is determined that the acquired illumination does not belong to the middle level range (i.e. “no” in step S7), then in step S10, the microcomputer unit 5 outputs the backlight control signal to the luminosity controller 6 so that the luminosity gradually changes from the current luminosity to 60% luminosity, which is the minimum of the luminosity range during the time period A. If current luminosity is already 60%, the microcomputer unit 5 does not output the backlight control signal, thus the 60% luminosity is maintained.

When it is determined that the acquired time is not within the time range A (i.e. “no” in step S2), then in step S3, the microcomputer unit 5 determines whether the time is within the time range B. If the time is within the range B, the microcomputer unit 5 determines the luminosity control range of the backlight 7 to be between 80% and 40%, then proceeds to step S11.

In step S11, the microcomputer unit 5 acquires illumination information based on the illumination detection signal from the illumination sensor 3. The microcomputer unit 5 then determines whether the acquired illumination belongs to the high level range among the level ranges of high, middle, and low. If the illumination belongs to high range (i.e. “yes” in step S12), then in step S14, the microcomputer unit 5 outputs the backlight control signal to the luminosity controller 6 so that the luminosity gradually changes to 80% luminosity, which is the maximum of the luminosity control range in time range B, from the current luminosity. By a PWM drive signal from the luminosity controller 6, the luminosity of the backlight 7 changes to 80% luminosity from the current luminosity. If current luminosity is already 80%, the microcomputer unit 5 does not output the backlight control signal, thus the 80% luminosity is maintained.

When it is determined that the acquired illumination does not belong to the high level range (i.e. “no” in step S12), then in step S13, the microcomputer unit 5 judges whether the acquired illumination belongs to the middle level range. If the illumination belongs to the middle level range (i.e. “yes” in step S13), then in step S15, the microcomputer unit 5 outputs the backlight control signal to the luminosity controller 6 so that the luminosity gradually changes from the current luminosity to 60% luminosity, which is the average of the luminosity control range in time range B. By a PWM drive signal from the luminosity controller 6, the luminosity of the backlight 7 changes from the current luminosity to 60% luminosity. If current luminosity is already 60%, the microcomputer unit 5 does not output the backlight control signal, thus the 60% luminosity is maintained.

When it is determined that the acquired illumination does not belong to the middle level range (i.e. “no” in step S13), then in step S16, the microcomputer unit 5 outputs the backlight control signal to the luminosity controller 6 so that the luminosity gradually changes from the current luminosity to 40% luminosity, which is the minimum of the luminosity range in time range B. By a PWM drive signal from the luminosity controller 6, the luminosity of the backlight 7 changes from the current luminosity to 40% luminosity. If current luminosity is already 40%, the microcomputer unit 5 does not output the backlight control signal, thus the 40% luminosity is maintained.

When it is determined that the acquired time is not within the time range B (i.e. “no” in step S3), then in step S4, the microcomputer unit 5 outputs the backlight control signal to the luminosity controller 6 so that the luminosity gradually changes from the current luminosity to 25% luminosity. By a PWM drive signal from the luminosity controller 6, the luminosity of the backlight 7 changes from the current luminosity to 25% luminosity. If current luminosity is already 25%, the microcomputer unit 5 does not output the backlight control signal, thus the 25% luminosity is maintained.

For example, in time range between 9 am to 6 pm in January, if the illumination is high because of the direct sunlight, the luminosity is set to 100% according to step S8. If the illumination is fairly high though there is no direct sunlight, the luminosity is set to 80% according to step S9. If the luminosity is low because of cloudy or rainy weathers, the luminosity is set to 60% according to step S10. In this time range, the luminosity control range is limited to 40% in maximum, and accordingly persons looking at the liquid crystal display may not feel uncomfortable. Further, the luminosity can be changed relatively quickly. The same applies to the case when a vehicle, such as a bus, stops in front of a liquid crystal display frequently. Further, when it is dark all day long (such as on a rainy day), the luminosity changes gradually, such as 60% in daytime (step S10), 40% in evening (step S16), and 25% in nighttime (step S4), and accordingly viewers of the displays do not feel uncomfortable.

The reason that the luminosity is changed in three steps depending on the illumination information, rather than using a proportionality function between the illumination and the luminosity in a procedure shown in FIG. 2, is that a frequent change of luminosity makes viewers of liquid crystal displays uncomfortable. Thereby the frequent change is suppressed.

In steps S5 and S11 of FIG. 2, though an instantaneous illumination at the time is acquired, the average illumination in a predetermined time may be acquired instead. For example, the microcomputer unit 5 may sample the detection signal from the illumination sensor 3 every second, compute an average illumination in a span of 100 seconds, update the illumination information to the computed average illumination, and acquire the updated information in steps S5 or S11. Thereby, the influence from an instantaneous but transitory environmental change (i.e. crossing of vehicles in front of the liquid crystal display 10) can be suppressed.

Following modification may be applied to the embodiment of the present invention.

For example, a direction sensor may be located on the liquid crystal display 10, and the procedure of FIG. 2 may be done after the microcomputer unit 5 recognizes the installation direction of the liquid crystal display 10 according to the detection signal from the direction sensor. If the direction recognized by the sensor is west, Table 2 may be used in steps S2 and S3 instead of Table 1. If the direction is south, Table 3 may be used instead. If the direction is east, Table 4 may be used. If the direction is north, Table 5 may be used. Here, Table 2 to 5 shows a relationship between the time and luminosity control range of the backlight 7, when direction is west, south, east, and north respectively, and is based on the meteorological data of London.

TABLE 2

| | | | Time |
|---|---|---|---|
| | | | Range C |
| | Time Range A | Time Range B | Fixed |
| | 100% to 60% | 80% to 40% | to 25% |
| January | 1 pm to 3 pm | 9 am to 1 pm or 3 pm to 5 pm | Otherwise |
| February | 1 pm to 4 pm | 8 am to 1 pm or 4 pm to 5 pm | Otherwise |
| March | 12 pm to 5 pm | 7 am to 12 pm or 5 pm to 7 pm | Otherwise |
| April | 11 am to 7 pm | 7 am to 11 am or 7 pm to 8 pm | Otherwise |
| May | 10 am to 8 pm | 6 am to 10 am or 8 pm to 9 pm | Otherwise |
| June | 9 am to 8 pm | 5 am to 9 am or 8 pm to 9 pm | Otherwise |
| July | 9 am to 8 pm | 6 am to 9 am or 8 pm to 9 pm | Otherwise |
| August | 10 am to 8 pm | 6 am to 10 am or 8 pm to 9 pm | Otherwise |
| September | 11 am to 7 pm | 7 am to 11 am or 7 pm to 8 pm | Otherwise |
| October | 1 pm to 5 pm | 8 am to 1 pm or 5 pm to 6 pm | Otherwise |
| November | 1 pm to 3 pm | 8 am to 1 pm or 3 pm to 4 pm | Otherwise |
| December | 1 pm to 2 pm | 9 am to 1 pm or 2 pm to 4 pm | Otherwise |

TABLE 3

| | | | Time |
|---|---|---|---|
| | | | Range C |
| | Time Range A | Time Range B | Fixed to |
| | 100% to 60% | 80% to 40% | 25% |
| January | 9 am to 4 pm | 8 am to 9 am or 3 pm to 5 pm | Otherwise |
| February | 8 am to 4 pm | 7 am to 8 am or 4 pm to 5 pm | Otherwise |
| March | 8 am to 4 pm | 6 am to 8 am or 5 pm to 6 pm | Otherwise |
| April | 8 am to 5 pm | 7 am to 8 am or 5 pm to 7 pm | Otherwise |
| May | 8 am to 5 pm | 6 am to 8 am or 5 pm to 8 pm | Otherwise |
| June | 8 am to 5 pm | 5 am to 8 am or 5 pm to 8 pm | Otherwise |
| July | 8 am to 6 pm | 6 am to 8 am or 6 pm to 9 pm | Otherwise |
| August | 8 am to 6 pm | 6 am to 8 am or 6 pm to 8 pm | Otherwise |
| September | 8 am to 5 pm | 7 am to 8 am or 5 pm to 7 pm | Otherwise |
| October | 8 am to 5 pm | 7 am to 8 am or 5 pm to 6 pm | Otherwise |
| November | 8 am to 3 pm | 7 am to 8 am or 3 pm to 4 pm | Otherwise |
| December | 9 am to 3 pm | 8 am to 9 am or 3 pm to 4 pm | Otherwise |

TABLE 4

| | | | Time |
|---|---|---|---|
| | | | Range C |
| | Time Range A | Time Range B | Fixed to |
| | 100% to 60% | 80% to 40% | 25% |
| January | 9 am to 11 am | 8 am to 9 am or 11 am to 4 pm | Otherwise |
| February | 8 am to 12 pm | 7 am to 8 am or 12 pm to 5 pm | Otherwise |
| March | 7 am to 12 pm | 6 am to 7 am or 12 pm to 6 pm | Otherwise |
| April | 7 am to 3 pm | 6 am to 7 am or 3 pm to 7 pm | Otherwise |
| May | 6 am to 4 pm | 5 am to 6 am or 4 pm to 8 pm | Otherwise |
| June | 6 am to 5 pm | 5 am to 6 am or 5 pm to 9 pm | Otherwise |
| July | 6 am to 5 pm | 5 am to 6 am or 5 pm to 9 pm | Otherwise |
| August | 6 am to 4 pm | 5 am to 6 am or 4 pm to 8 pm | Otherwise |
| September | 7 am to 2 pm | 6 am to 7 am or 2 pm to 7 pm | Otherwise |
| October | 8 am to 12 pm | 7 am to 8 am or 12 pm to 6 pm | Otherwise |
| November | 8 am to 11 am | 7 am to 8 am or 11 am to 4 pm | Otherwise |
| December | 9 am to 11 am | 8 am to 9 am or 11 am to 3 pm | Otherwise |

TABLE 5

| | | Time | |
|---|---|---|---|
| | Time Range A | Range B | Time Range C |
| | 100% to 60% | 80% to 40% | Fixed to 25% |
| January | — | 8 am to 5 pm | Otherwise |
| February | — | 7 am to 6 pm | Otherwise |
| March | — | 6 am to 7 pm | Otherwise |
| April | — | 6 am to 8 pm | Otherwise |
| May | — | 5 am to 9 pm | Otherwise |
| June | — | 5 am to 9 pm | Otherwise |
| July | — | 5 am to 9 pm | Otherwise |
| August | — | 5 am to 9 pm | Otherwise |
| September | — | 6 am to 8 pm | Otherwise |
| October | — | 7 am to 6 pm | Otherwise |
| November | — | 7 am to 5 pm | Otherwise |
| December | — | 8 am to 4 pm | Otherwise |

According to this modified embodiment, luminosity can be controlled adequately according to the installation direction of the liquid crystal display 10, and thus the visibility improves. The direction information may be set to microcomputer unit 5 manually from an external server via a LAN (Local Area Network), or from the controller equipped with the liquid crystal display 10.

Further, the microcomputer unit 5 may recognize a direction, based on a stored solar radiation data acquired from the illumination sensor 3. For example, as shown in FIG. 3, the microcomputer unit 5 may store the solar radiation data acquired from the illumination sensor 3 every hour, compute an average difference between the standard and the stored solar radiation data for each direction (i.e. north, south, east and west), and recognize the direction of the liquid crystal display 10 based on the minimum computed average.

In the above-mentioned embodiment, Table 1 used in the procedure of FIG. 2 is assumed to be constant. Instead, data in Table 1 may be updated according to the data stored in the microcomputer unit 5 which is acquired every hour from the illumination sensor 3. Thereby, the luminosity can be set adequately, according to the installation environment of the liquid crystal display 10, and thus the visibility improves.

The present invention is not limited to the foregoing embodiment but can be modified variously by one skilled in the art without departing from the spirit of the invention as set forth in the appended claims.

For example, the installing area information may be input to the microcomputer unit 5 either from a GPS (Global Position System) device installed in liquid crystal display, or manually, and the procedure shown in FIG. 2 may be achieved by using tables (such as Tables 1 to 5) which are set in each installation location. In this case, the microcomputer unit 5 has relational data between the time and the luminosity control range for every installation area.

Moreover, the present invention is applicable not only to liquid crystal displays but also to self-emitting type displays such as plasma displays, or organic electroluminescence displays.

What is claimed:

1. A display apparatus, comprising:
an illumination acquisition part acquiring the illumination level of daylight that is representative of an amount of daylight on the display,
a time acquisition part acquiring date and/or time,
a control part controlling display luminosity according to the output of the illumination acquisition part, wherein
the control part is characterized by determining the control range of a display luminosity based on the date and/or time the time acquisition part acquired.

2. A display apparatus according to claim 1, wherein
the control part recognizes the installation direction of the display and determines the controlling range of display luminosity based on the recognized installation direction.

3. A display apparatus according to claim 1, wherein
the control part stores the solar radiation data based on the output of the illumination acquisition part, and determines the control range of display luminosity based on the stored data.
